(19) United States
(12) Patent Application Publication
(10) Pub. No.: US 2012/0255114 A1
(43) Pub. Date: Oct. 11, 2012

(54) PRE-PLUMBED SHOWER PANEL WITH CLUSTERED JETS

(75) Inventors: Donald W. Reeves, Scotts Valley, CA (US); Scott Reeves, Pleasanton, CA (US)

(73) Assignee: Lifetouch Innovations LLC, Santa Cruz, CA (US)

(21) Appl. No.: 13/441,878

(22) Filed: Apr. 7, 2012

Related U.S. Application Data
(60) Provisional application No. 61/473,518, filed on Apr. 8, 2011.

(51) Int. Cl. A47K 3/28; B23P 17/04

(52) U.S. Cl. 4/596; 29/401.1

(57) ABSTRACT

An existing shower is retrofitted with a novel shower panel that uses the existing on/off water pressure and temperature control valve without any re-plumbing behind the shower wall. The shower panel includes a support frame, a diverter valve, a plurality of water jets, a side showerhead, a hand nozzle and an overhead showerhead. The support frame has an open side that faces the shower wall. A first tube connects the diverter valve to the plurality of water jets. A second tube is connected to the diverter valve at a first end and has a threaded connector at the second end. The threaded connector is adapted to connect to a shower water source after the existing shower pipe is removed. The first tube has a smaller diameter than does the second tube. The plurality of water jets are arranged within a square that is twenty-five centimeters on a side.

### CROSS REFERENCE TO RELATED APPLICATION

This application claims the benefit under 35 U.S.C. §119 of provisional application Ser. No. 61/473,518, entitled “Pre-Plumbed Shower Panel With Clustered Jets”, filed Apr. 8, 2011. The subject matter of provisional application Ser. No. 61/473,518 is incorporated herein by reference.

### TECHNICAL FIELD

The described embodiments relate to shower and bath appliances, and specifically to an easily installed shower panel with clustered water jets that uses the existing shower valve.

### BACKGROUND INFORMATION

FIG. 1 (Prior Art) is a perspective diagram of a conventional showerhead 10 that extends from a surface of shower wall 11. Showerhead 10 is a typical showerhead that includes a rotating bezel 12 that allows a user to adjust the spray emitted from showerhead 10. For example, by rotating bezel 12, a user can change the spray emitted from a continuous stream, to a spray that is emitted in short, concentrated bursts providing a massaging effect on the user. Unfortunately, such conventional showerheads are often limited in where they can massage the user. For example, the position of showerhead 10 makes it difficult for the user to massage their lower back. Moreover, installing another showering fixture is often costly and involves extensive plumbing. A robust and low-cost solution is desired.

### SUMMARY

A self-plumbed shower panel includes multiple massage water jets, a hand nozzle and a showerhead built into a shower panel that mounts onto a shower wall. A water supply tube of the shower panel connects to the existing water source after the existing showerhead is removed. The existing shower pipe is removed, and the water supply tube of the shower panel is connected to the source water pipe at the wall. The existing valves or single-handle mixer arc are used to turn the water supply on and off and to control the mix of hot and cold water. The shower panel is attached to the shower wall using two mounting brackets and is hung above the existing mixer tap.

The shower panel includes six powerful tilting multi-function massage jets aligned with the critical muscle groups in the upper back, neck and shoulders of the user. The shower panel offers jet clustering that targets water pressure where it is needed most. Water jets tilt to suit every individual. Several functions allow for a deep back massage or relaxing, toning mist. The centered tilting “turbojet” adjusts to focus maximum water pressure on problem areas of the back, shoulders and neck, washing away soreness, stress and fatigue. The user can select from multiple rejuvenating massage functions for complete control over muscle health. The shower panel is designed to maximize the power of water, turning standard water pressure into high-pressure spray. An invigorating massage therapy with lower water consumption is produced using a simplified internal design, a shorter distance from water supply to jet outlets, and a succession of power increasing compression hoses. Additionally, the massage jets are designed with smaller outlet holes and more efficient internal design than prior art massage jets, yielding increased water pressure as compared to prior art massage jets.

In one embodiment, the shower panel includes six water jets arranged in two vertical columns of three jets, and a side showerhead disposed at a center of the shower panel. The shower panel is installed on the shower wall by aligning the top two water jets with the user's shoulder blades. The water jets are arranged closer together than prior art massage jets. In another embodiment, the water jets fit within a square that is 25 centimeters on each side. The top two water jets are placed somewhat closer to each other than are the bottom two pairs of jets. In yet another embodiment, the top two water jets are arranged the same distance to each other than are the bottom two pairs of jets. In yet another embodiment, the centers of the top two water jets are about 17 centimeters apart. In yet another embodiment, the frame of the shower panel is about 90 centimeters long and about 30 centimeters wide. The water jets are clustered at the bottom of the frame. The side showerhead, also referred to as a “turbojet”, is located between the bottom four water jets. The turbojet is a modified showerhead that sprays water from the side, and emits water at a pressure greater than water emitted from one of the outer water jets. The direction of the side showerhead can be adjusted to focus the water spray at a specific location on the user's back or neck. A four-way diverter valve is adjustable to divert water exclusively to one of: the rain-style overhead showerhead, the hand nozzle, the outer water jets, or the side showerhead (“turbojet”).

In yet another embodiment, a shower retrofitting kit is provided to a user. The shower retrofitting kit includes a novel shower panel, printed instructions, and a container. The printed instructions instruct the user on how to perform the retrofit of her pre-existing shower to incorporate the novel shower panel. The retrofitting is performed by removing the pre-existing showerhead, attaching mounting anchors to a surface of the shower wall, connecting the shower panel directly to the water source, and hanging the shower panel on the mounting anchors. The container is used to store the shower panel and the printed instructions.

Further details and embodiments and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (prior art) is a perspective diagram of a conventional showerhead 10.

FIG. 2 is a perspective diagram of a novel shower panel 100.

FIG. 3 is a diagram of a back view of the shower panel of FIG. 2 that shows the plumbing of the shower panel.

FIG. 4 is a front view diagram of the shower panel.

FIG. 5 is a side view diagram of the shower panel.

FIG. 6 is a diagram showing an expanded view of a control handle and a plurality of selectable modes of the shower panel.

FIG. 7 is a diagram showing water jets that are adjusted to emit a steady jet spray on a mid-back of the user.

FIG. 8 is a perspective diagram showing one technique for removing a pre-existing showerhead from a surface of the shower wall.

FIG. 9 is a perspective diagram showing how to use a tape measure to evaluate the length for a new wall pipe to be installed.

FIG. 10 illustrates an amount of threaded wall pipe to be measured.

FIG. 11 is a perspective diagram showing how the trimmed wall pipe is attached and secured onto the pre-existing water source.

FIG. 12 is a perspective diagram showing how a template is used to determine where mounting anchors should be placed.

FIG. 13 is a perspective diagram showing a hand drill used to drill a screw along each of the marked drill locations.

FIG. 14 is a perspective diagram showing mounting anchors screwed into place at the corresponding holes drilled in FIG. 13.

FIG. 15 is a perspective diagram of yet another technique for attaching mounting anchors onto the shower wall.

FIG. 16 is a perspective diagram showing how the shower panel is connected to the pre-existing water source.

FIG. 17 is a perspective diagram showing how the shower panel is attached to the shower wall by hanging wall mounts onto the mounting anchors.

FIG. 18 is a diagram of a novel shower retrofitting kit.

FIG. 19 is a flowchart of a method for retrofitting a pre-existing shower in accordance with one novel aspect.

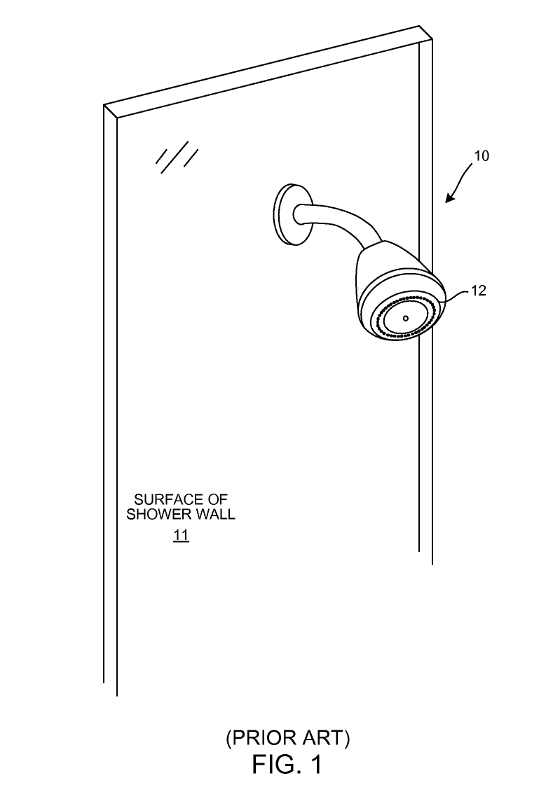

### DETAILED DESCRIPTION

Reference will now be made in detail to some embodiments of the invention, examples of which are illustrated in the accompanying drawings.

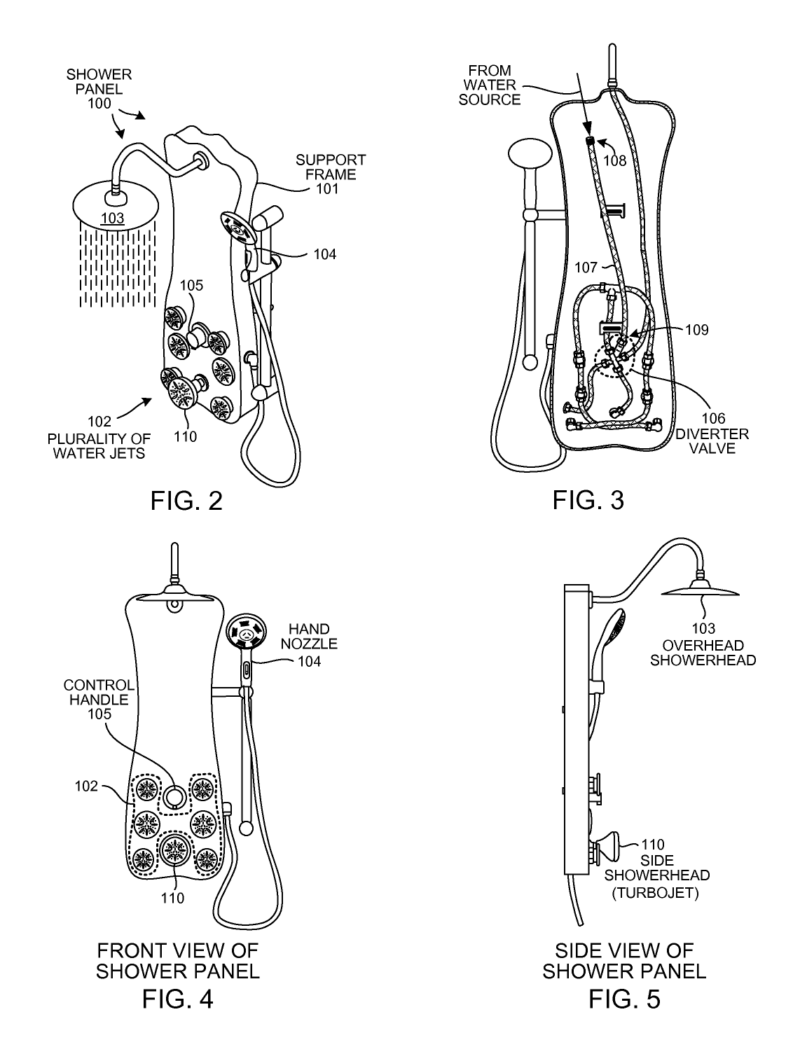

FIG. 2 is a perspective diagram of a novel shower panel 100. Shower panel 100 comprises a support frame 101, a plurality of water jets 102, an overhead shower 103, a hand nozzle 104, a control handle 105, and a side showerhead 110. Any pre-existing shower stall or pre-existing shower tub is retrofittable to support novel shower panel 100. The retrofit process involves connecting the shower panel directly to the water source and hanging shower panel 100 on mounting anchors attachable to a surface of the shower wall. Shower panel 100 utilizes the pressure balance valve and temperature control valve of the pre-existing shower without any further modification or re-plumbing behind the shower wall.

FIG. 3 is a diagram of a back view of shower panel 100 that shows the plumbing of shower panel 100. Shower panel 100 further comprises a diverter valve 106, a tube 107, and a plurality of distribution tubes. In the example of FIG. 3, tube 107 and the plurality of distribution tubes are braided, flexible, stainless steel water hoses. In other embodiments, the tubes are polyurethane tubes, or polyvinyl chloride (PVC) tubes. (The term “tube” is also referred to as a “hose” in the art, and the terms can be used interchangeably.) A first end 108 of tube 107 connects directly to the pre-existing water source of the shower, and a second end 109 of tube 107 connects to diverter valve 106. During operation, water flows from the water source, into first end 108, through tube 107, and out of end 109 into diverter valve 106. Diverter valve 106 uses the distribution valves to supply the flowing water exclusively to one of water jets 102, overhead showerhead 103, hand nozzle 104, or side showerhead 110. The manner in which diverter valve 106 supplies water to various nozzles of shower panel 100 is dependent upon the configuration of diverter valve 106. Diverter valve 106 is configured by the user via control handle 105 to operate in one of a plurality of selectable modes of operation as shown in FIG. 6. FIG. 4 is a front view diagram of shower panel 100. FIG. 5 is a side view diagram of shower panel 100.

Side showerhead 110 of shower panel 100 is of larger dimensions and emits water at a substantially greater force than each of water jets 102. Due to this greater force, side showerhead 110 is referred to as a “turbojet”. In addition, side showerhead 110 includes greater tilting range and more water-emitting styles than each of water jets 102. The plurality of water jets 102 is arranged within a square that is 25 centimeters on a side. Control handle 105 and side showerhead 110 are disposed within the square in which the plurality of water jets 102 is arranged. In another embodiment, the plurality of water jets 102 is arranged within a square that is between 25 and 35 centimeters on a side.

In accordance with another novel aspect, shower panel 100 is pre-plumbed and does not require any plumbing during the retrofit process. The back view illustrated in FIG. 3 is also referred to as the “open side” of shower panel 100 because the inner plumbing of shower panel 100 is viewable and accessible. After shower panel 100 is installed, the open side will be adjacent to a surface of the shower wall and will be hidden from the view of the user.

FIG. 6 is a diagram showing an expanded view of control handle 105 and the plurality of selectable modes of shower panel 100. A user selects the mode of operation by rotating control handle 105. Control handle 105 is coupled directly to diverter valve 106. Diverter valve 106 is operable in one of several modes. Such modes include diverting water exclusively through water jets 102 (labeled “A”), exclusively through side showerhead 110 (“turbojet”) (labeled “B”), exclusively through overhead showerhead 103 (labeled “C”), and exclusively through hand nozzle 104 (labeled “D”).

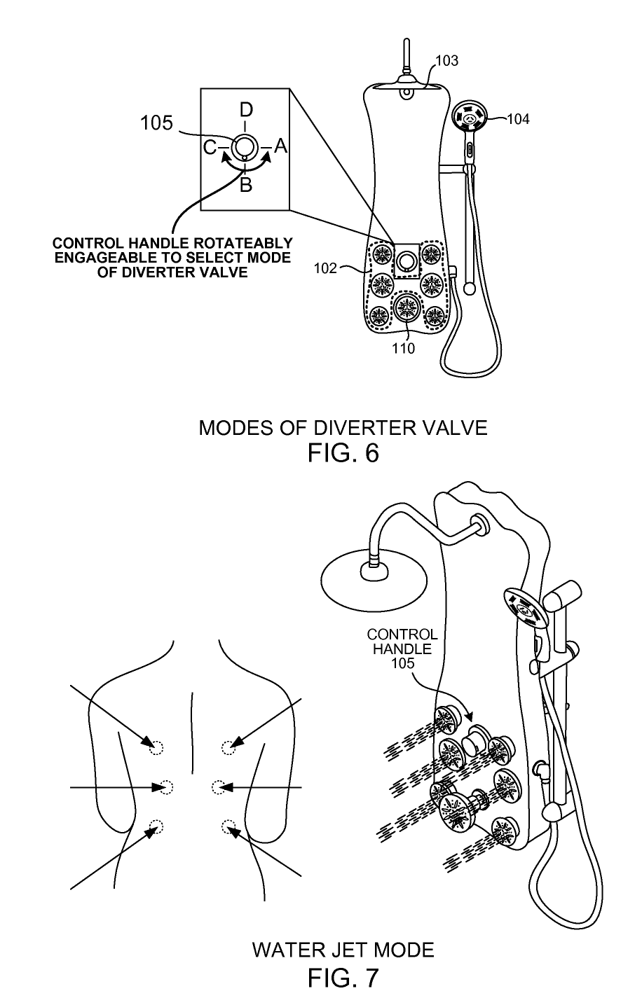

FIG. 7 is a diagram showing water jets 102 adjusted to emit a steady jet spray on a mid-back of a user. In accordance with one novel aspect, the direction in which the jet spray is emitted by each of the water jets 102 is adjustable by the user. The user can adjust the nozzle of each individual water jet such that each of the emitted jet sprays targets a specific desired location, for example, the upper body, neck, back and shoulders of the user. Accordingly, the user rotates each of the water jets 102 until the position of each jet spray is directed to a desired portion of the body.

In accordance with another novel aspect, the type of jet spray that is emitted by each of the water jets 102 is also adjustable. The user rotates each individual water jet clockwise or counter-clockwise until the desired spray is emitted. Several types of jet sprays are available. In one example, the jet spray is adjusted to emit a steady, broad jet spray. In another example, the jet spray is adjusted to emit a jet spray in short, concentrated bursts.

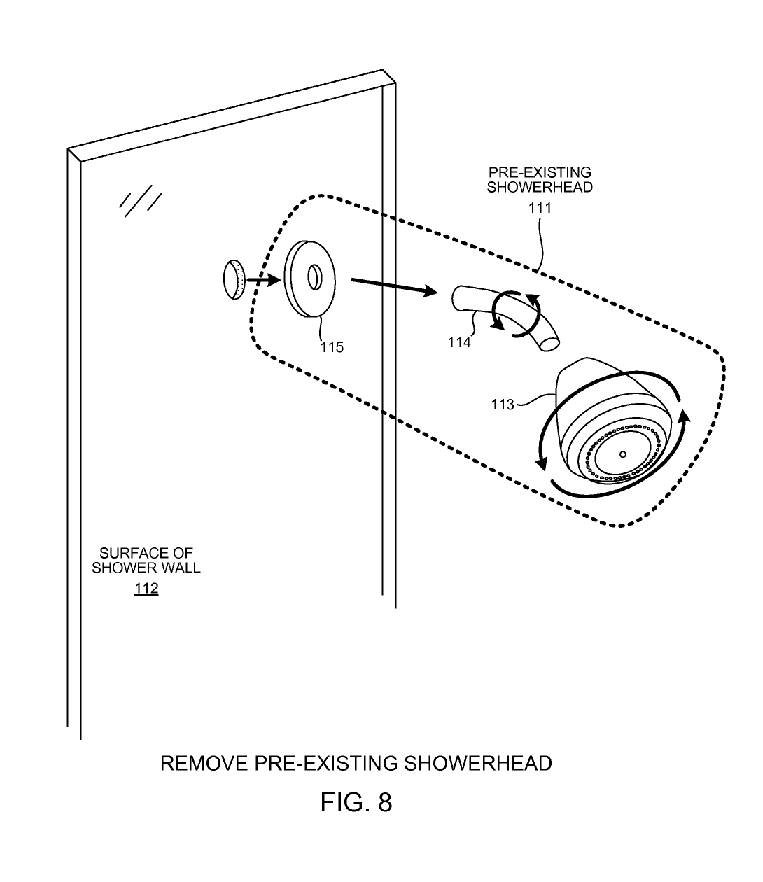

One technique for retrofitting a pre-existing shower with novel shower panel 102 is shown in FIGS. 8 through 17 that follow.

FIG. 8 is a perspective diagram showing one technique for removing a pre-existing showerhead 111 from a surface of shower wall 112. In the example of FIG. 8, a pre-existing showerhead 111 is removed by first unscrewing showerhead nozzle 113. Shower arm 114 is removed in a similar fashion, typically requiring the use of an adjustable wrench to disconnect shower arm 114 from the permanent fitting inside shower wall 112. After showerhead nozzle 113 and shower arm 114 are removed, escutcheon 115 is pried out by leveraging a screwdriver between escutcheon 115 and shower wall 112. Novel shower panel 100 is installable after removal of pre-existing showerhead 111.

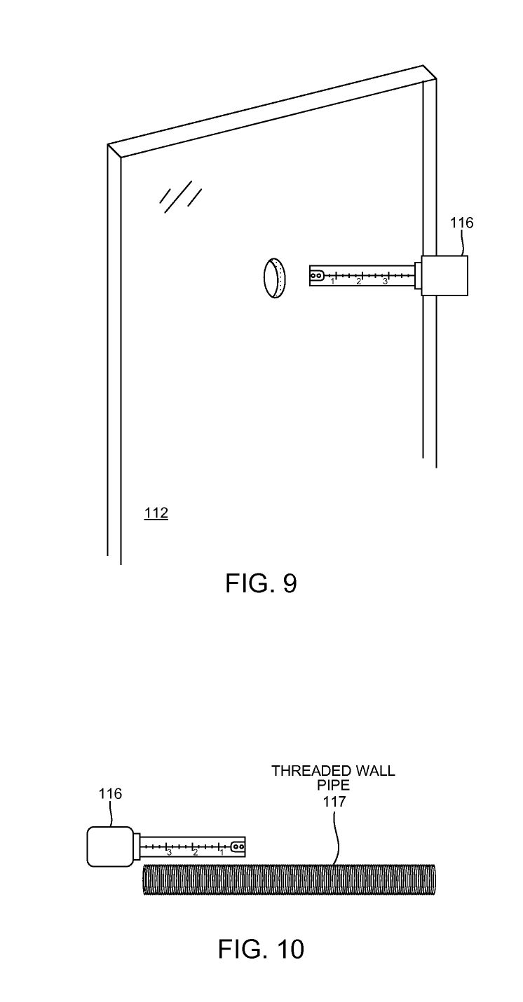

FIG. 9 is a perspective diagram showing how to use tape measure 116 to evaluate a length for a new wall pipe to be installed. Typically, the new wall pipe protrudes from the wall no more than of 1-½ inches. If the wall pipe protrudes more than 1-½ inches, then the wall pipe will likely interfere with attachability of shower panel 100. Accordingly, tape measure 116 is used to measure a distance from the water source within surface wall 112 to protrude from between 1 inch to 1-½ inches. FIG. 10 illustrates an amount of threaded wall pipe 117 to be measured. After the required length of pipe is determined, threaded wall pipe 117 is trimmed to the desired length.

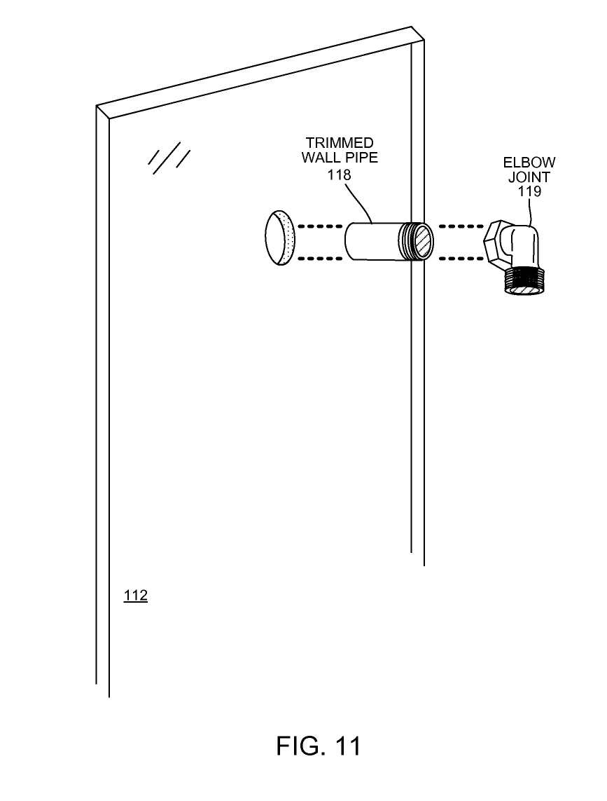

FIG. 11 is a perspective diagram showing how trimmed wall pipe 118 is attached and secured onto the pre-existing water source. Prior to attaching trimmed wall pipe 118 to the water source, a thread seal tape is applied to the threads on pipe 118 to minimize leakage of water. After applying the thread seal tape, a first end of pipe 118 is screwed onto the water source. After tightening pipe 118, elbow joint 19 is screwed onto a second end of pipe 118.

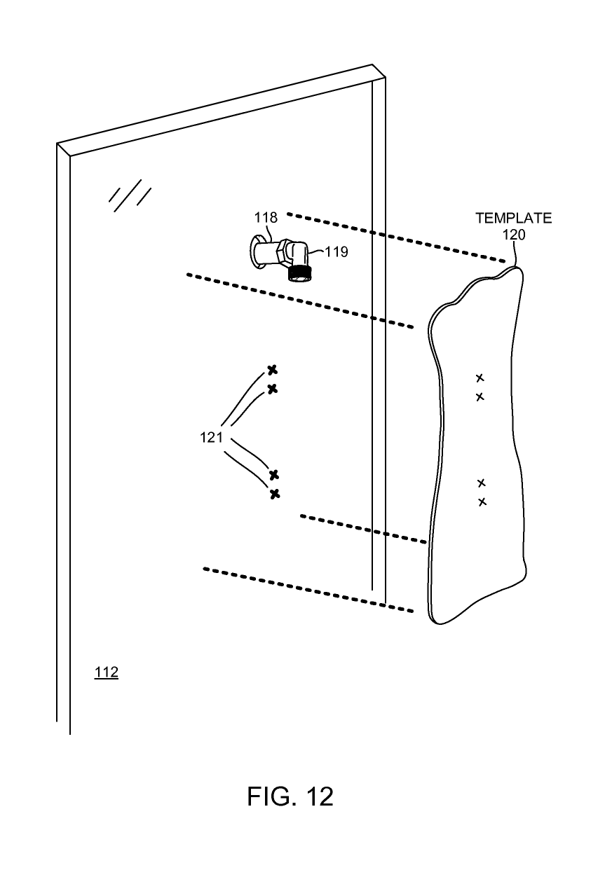

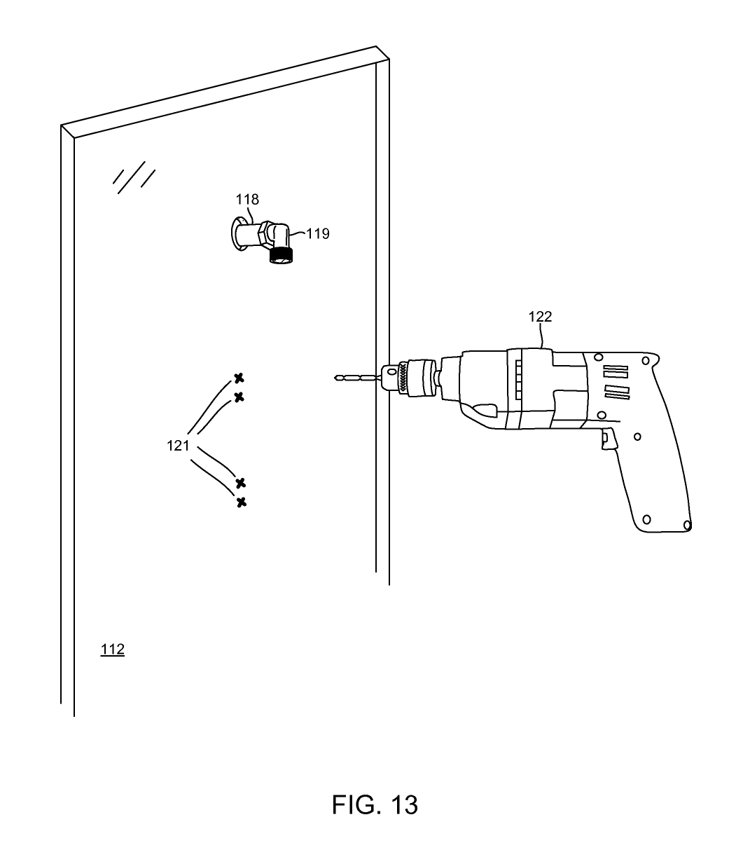

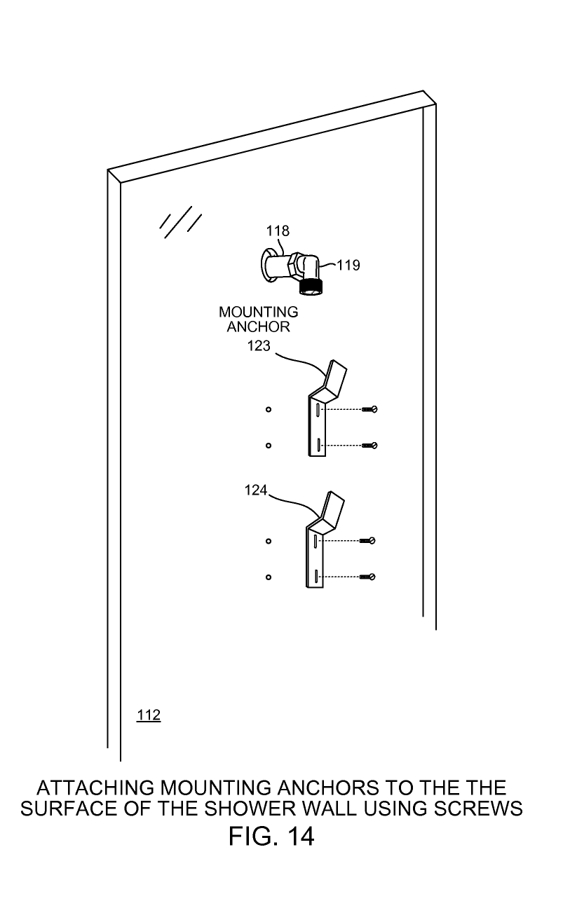

FIG. 12 is a perspective diagram showing how template 120 is used for determining where mounting anchors should be placed. In this example, template 120 is a single sheet of thick paper having the same height and length of the shower panel 100. Placing template 120 against shower wall 112 allows a user to visualize placement of shower panel 100. In particular, template 120 includes marks showing the position along shower wall 112 onto which mounting anchors must be installed. A pencil is used to mark a plurality of drill locations 121 indicating points along shower wall 112 for drilling screw holes. FIG. 13 is a perspective diagram showing how hand drill 122 is used to drill along each of the marked drill locations 121. FIG. 14 is a perspective diagram showing mounting anchors 123 and 124 screwed into place at the corresponding holes drilled in FIG. 13.

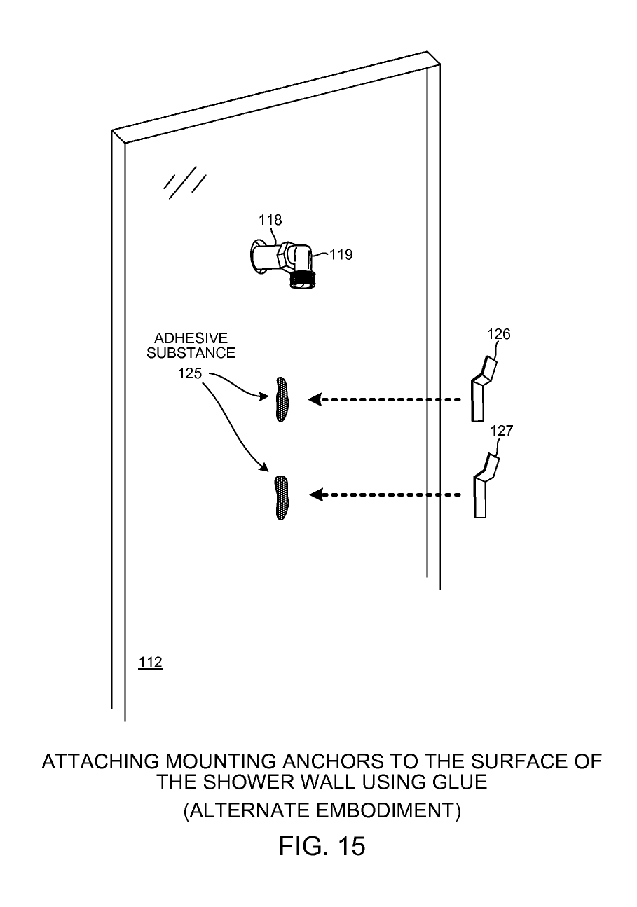

FIG. 15 is a perspective diagram of yet another technique for attaching mounting anchors onto shower wall 112. In the example of FIG. 15, adhesive substance 125 is used to glue mounting anchors 126 and 127 to their designated locations along shower wall 112.

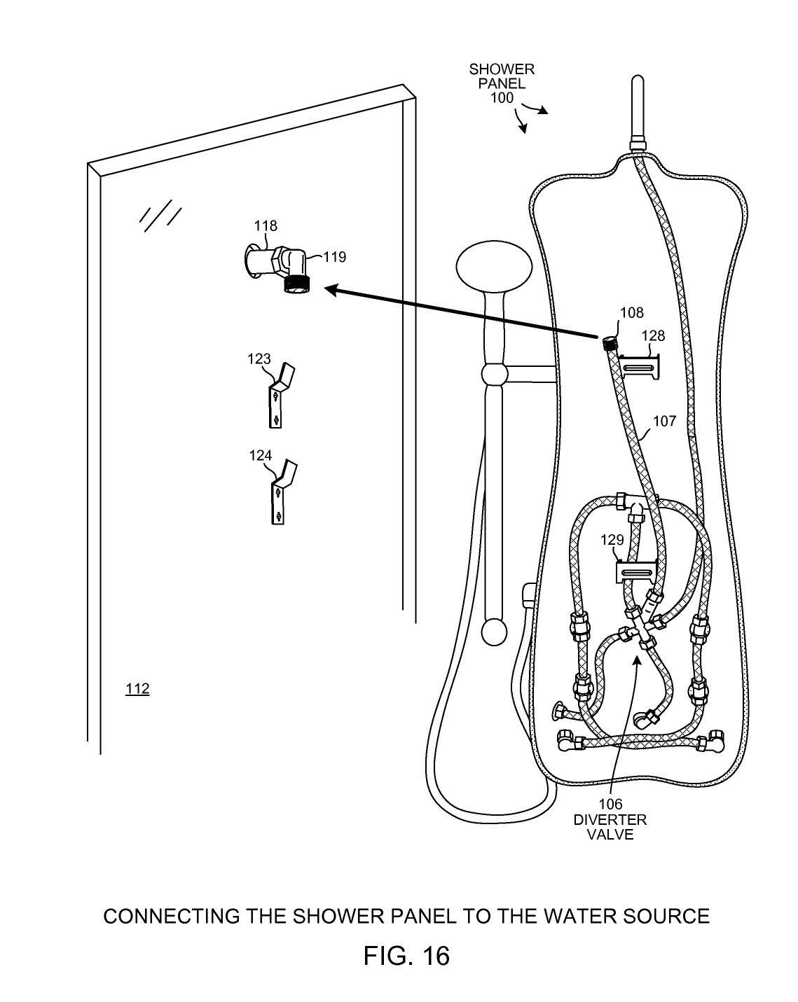

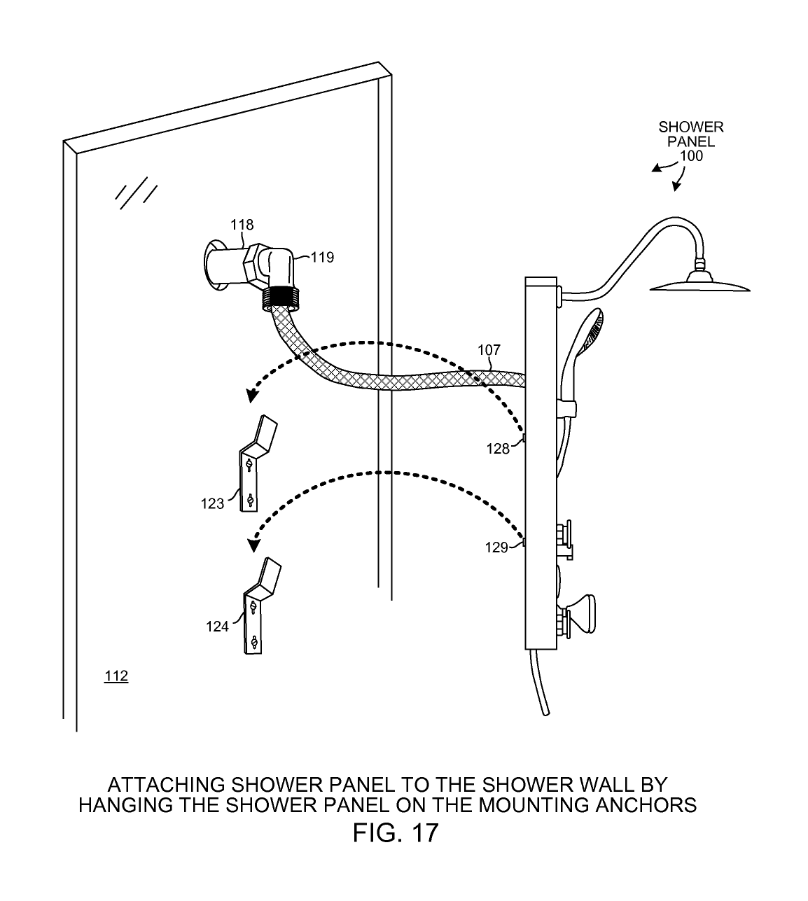

FIG. 16 is a perspective diagram showing how shower panel 100 is connected to the pre-existing water source. A first end 108 of tube 107 is screwed and fastened onto elbow 119 allowing water to flow from the water source through pipe 118, through elbow 119, through pipe 107, and into diverter valve 106 where the water is directed to selected nozzles of shower panel 100. After shower panel 100 is connected to the water source, shower panel 100 can then be hung on mounting anchors 123 and 124. Shower panel 100 includes an upper wall mount 128 and a lower wall mount 129. Upper wall mount 128 is designed to hang on mounting anchor 123, and lower wall mount 129 is designed to hang on mounting anchor 124. FIG. 17 is a perspective diagram showing how shower panel 100 is attached to shower wall 112 by hanging wall mounts 128 and 129 onto the mounting anchors 123 and 124.

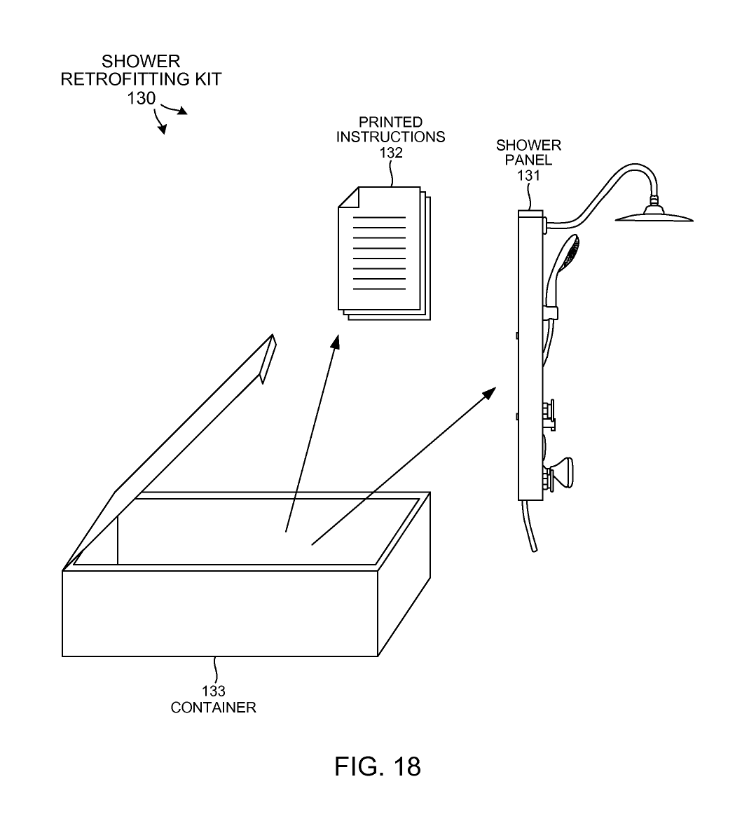

FIG. 18 is a diagram of a novel shower retrofitting kit 130. Shower retrofitting kit 130 comprises a shower panel 131, printed instructions 132, and container 133. Shower panel 131 is substantially similar to shower panel 100 of FIGS. 2-17. Container 133 is used to store shower panel 131 and printed instructions 132 for packaging and shipping to a user. In one embodiment, shower retrofitting kit 130 is manufactured by a first entity, and then sold to a second entity (a user) that uses kit 130 to retrofit a shower. The user follows printed instructions 132 in order to retrofit her pre-existing shower to include shower panel 131. Printed instructions 132 include instructions directing the user to perform the steps set forth in FIGS. 8 through 17. In this fashion, the user can upgrade her shower to include massaging jet sprays and a flexible hand nozzle. In addition, the upgrade is obtained using kit 130 without removing or altering the shower wall, nor performing any plumbing behind the shower wall.

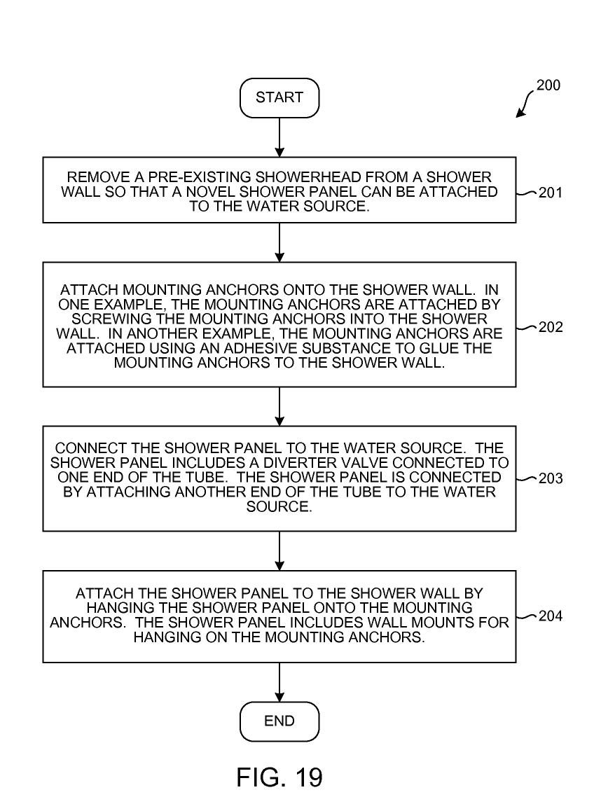

FIG. 19 is a flowchart of a method 200 for retrofitting a pre-existing shower in accordance with one novel aspect. In a first step (step 201), a user removes a pre-existing showerhead from a shower wall. For example, in FIG. 8, pre-existing showerhead 111 is disconnected and removed from the water source behind shower wall 112. In a second step (step 202), the user attaches mounting anchors onto the shower wall. The mounting anchors can be screwed into the shower wall or glued using an adhesive substance. For example, in FIG. 14, mounting anchors 123 and 124 are attached to shower wall 112 using screws. In the example of FIG. 15, mounting anchors 126 and 127 are glued to shower wall 112 using adhesive substance 126. In a third step (step 203), the shower panel is connected to the water source. The shower panel has a tube having one end attached to a diverter valve. Another end of the tube is connected to the water source thereby connecting the water source to the shower panel. For example, in FIG. 16, second end 108 of tube 107 is connected to the water source via elbow joint 119 and pipe 118. In a fourth step (step 204), the shower panel is attached to the shower wall using the mounting anchors. The shower panel includes wall mounts that are hung on the mounting anchors. For example, in FIG. 17, wall mounts 128 and 129 are hung onto mounting anchors 123 and 124.

Although certain specific exemplary embodiments are described above in order to illustrate the invention, the invention is not limited to the specific embodiments. The amount of mounting anchors used to attach shower panel 100 varies depending on the weight of shower panel 100 as well as the material composition of shower wall 112. In some embodiments, four mounting anchors (each having two screws) are used to attach shower panel 100 to shower wall 112 rather than the two mounting anchors used in FIGS. 14 and 15.

The quantity, type, and alignment of water jets included in the shower panel may also vary. For example, in one embodiment, the shower panel includes four outer water jets and two side showerheads (“turbojets”). The six water jets are aligned along three vertical axes. The diverter valve operates in one mode to divert water exclusively through the four outer water jets, and in another mode operates to divert water exclusively through the two “turbojets”. In another embodiment, the shower panel includes eight water jets arranged around a square that is between 25 and 35 centimeters on a side. The eight water jets include two “turbojets”. The control handle for controlling the diverter valve is located at a center of the square. The diverter valve operates in one mode to divert water exclusively through the six “normal” water jets, and in another mode the diverter valve operates to divert water exclusively through the two “turbojets”.

Accordingly, various modifications, adaptations, and combinations of various features of the described embodiments can be practiced without departing from the scope of the invention as set forth in the claims.

What is claimed is:

1. A method comprising:
removing a pre-existing showerhead;
attaching a mounting anchor to a surface of a shower wall;
connecting a shower panel to a water source using a tube having a first end and a second end, wherein the shower panel includes a support frame, a diverter valve and a plurality of water jets, and wherein the first end of the tube is connected to the diverter valve and the second end of the tube is connected to the water source; and
attaching the shower panel to the shower wall by hanging the shower panel on the mounting anchor.

2. The method of claim 1, wherein the connecting is performed by retrofitting a pre-existing shower to include the shower panel without altering any plumbing within the shower wall.

3. The method of claim 1, wherein the attaching is performed by drilling a hole into the shower wall and screwing the mounting anchor to the hole.

4. The method of claim 1, wherein the attaching is performed by using an adhesive substance to attach the mounting anchor to the surface of the shower wall.

5. The method of claim 1, wherein the plurality of water jets are arranged within a square that is 25 centimeters on a side.

6. The method of claim 1, wherein the shower panel is connected to the water source such that water flowing from the water source to the shower panel flows through the diverter valve.

7. The method of claim 1, wherein the shower panel includes a side showerhead disposed on a central axis of the shower panel.

8. The method of claim 7, wherein the diverter valve can divert water exclusively to one of the side showerhead, the plurality of water jets, a hand nozzle, or an overhead showerhead.

9. The method of claim 1, wherein the mounting anchor is attached to the water source.

10. A shower retrofitting kit comprising:
a shower panel comprising:
a support frame having a first side and a second side;
a diverter valve disposed on the first side of the support frame; and
a plurality of water jets disposed on the second side of the support frame, wherein each of the plurality of water jets is connected to the diverter valve, and wherein the plurality of water jets are arranged within a square that is 25 centimeters on a side;
printed instructions instructing a user to retrofit a shower by removing a pre-existing showerhead from a water source, attaching a mounting anchor to a shower wall, connecting the diverter valve to the water source, and hanging the shower panel on the mounting anchor; and
a container that contains the shower panel and the printed instructions.

11. The shower retrofitting kit of claim 10, wherein the printed instructions instruct the user to retrofit a pre-existing shower without altering any plumbing within the shower wall.

12. The shower retrofitting kit of claim 10, wherein the printed instructions instruct the user to attach the mounting anchor to the shower wall by screwing the mounting anchor to the shower wall.

13. The shower retrofitting kit of claim 10, wherein the printed instructions instruct the user to attach the mounting anchor to the shower wall using an adhesive substance.

14. The shower retrofitting kit of claim 10, wherein the printed instructions instruct the user to mount the shower panel above a pre-existing valve on the shower wall.

15. A shower panel comprising:
a support frame with an open side;
a diverter valve;
a plurality of water jets;
a first tube that connects the diverter valve to the plurality of water jets; and
a second tube connected to the diverter valve at a first end and having a threaded connector at a second end, wherein the threaded connector is adapted to connect to a shower water source, and wherein the plurality of water jets are arranged within a square that is 25 centimeters on a side.

16. The shower panel of claim 15, wherein the plurality of water jets are arranged approximately in two vertical columns.

17. The shower panel of claim 15, further comprising:
a side showerhead located on a central axis of the shower panel.

18. The shower panel of claim 17, wherein the diverter valve can divert water exclusively to one of the side showerhead, the plurality of water jets, a hand nozzle, or an overhead showerhead.

19. The shower panel of claim 15, wherein the shower panel includes a control handle that extends from the support frame and is coupled to the diverter valve, wherein the diverter valve is operable in one of a plurality of selectable modes, and wherein the control handle is rotateably engageable to select one of the selectable modes.

20. The shower panel of claim 15, wherein the second tube has a smaller diameter than does the first tube.
